(19) United States
(12) Patent Application Publication
(10) Pub. No.: US 2014/0203770 A1
(43) Pub. Date: Jul. 24, 2014

(54) SYSTEM AND METHOD FOR INDICATING CHARGING STATUS DURING WIRELESS CHARGING

(71) Applicant: FORD GLOBAL TECHNOLOGIES, LLC, Dearborn, MI (US)

(72) Inventors: Stuart C. Salter, White Lake, MI (US); Cornel Lewis Gardner, Romulus, MI (US); Jeffrey Singer, Canton, MI (US); John Robert Van Wiemeersch, Novi, MI (US); Michael Hrecznyj, Dearborn, MI (US)

(73) Assignee: FORD GLOBAL TECHNOLOGIES, LLC, Dearborn, MI (US)

(21) Appl. No.: 13/748,781

(22) Filed: Jan. 24, 2013

(51) Int. Cl. H02J 7/00

(52) U.S. Cl. CPC H02J 7/0047
USPC 320/108; 320/162

(57) ABSTRACT

A wireless charging system comprising a wireless charger for charging a chargeable device in a charging region in a vehicle. The system includes a controller that detects a charging status of the chargeable device in the charging region and an indicator in proximity to or on the charging region for indicating the charging status by illuminating one or more light sources.

### FIELD OF THE INVENTION

The present invention generally relates to wireless charging systems, and more particularly relates to indicating charging status during wireless charging of portable devices in a vehicle.

### BACKGROUND OF THE INVENTION

Portable battery operated electronic devices, such as cell phones, employ rechargeable batteries that must be recharged when battery charge is consumed. Typically, electric-powered or electronic devices are physically connected to an electrical charger via a wire connection. More recently, wireless charging devices such as inductive chargers are available to charge the battery without any physical wire connection between the electronic device and the charging device. Wireless chargers generate an electromagnetic field through the use of electromagnetic transducers to transfer the electric energy from the charging device to a receiver on a battery or device having a battery being charged. Inductive chargers generate a magnetic field through the use of inductive coils to transfer the electric energy from the charging device to a receiver on a battery or device having a battery being charged. Inductive chargers have been proposed for use on vehicles in various locations having a portable battery or a battery operated device within the cockpit of the vehicle, typically near the driver and other passengers, for the sake of convenience to allow easy access to the devices. During charging of the electronic device, there may be an indication of the charging status of the device on the charger. However, the conventional indication of the charging status of the device on the charger is typically too small to be easily noticeable to drivers, thereby often requiring occupants to take their eyes off the road in order to determine the charging state of the charger. It is therefore desirable to provide a wireless charger and/or system in a manner that allows the occupant of the vehicle to easily and readily determine the charging status of the device being charged without focusing their eyes off the road.

### SUMMARY OF THE INVENTION

According to one aspect of the present invention, a wireless charging system including a wireless charger for charging a chargeable device in a charging region in a vehicle is provided. The system also includes a controller that detects a charging status of the chargeable device in the charging region. The system further includes an indicator in proximity to or on the charging region for indicating the charging status by illuminating one or more light sources.

According to another aspect of the present invention, a method for indicating charging status in a wireless charging system is provided. The method also includes inductively charging a chargeable device with a wireless charger in a charging region in a vehicle. The method further includes detecting a charging status of the chargeable device and providing an indication of the charging status to a user wherein the indication is an illumination of one or more light sources provided in proximity to or on the charging region.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a cockpit of a vehicle employing a wireless charger at a potential charging region, according to one embodiment;

FIG. 2 is an enlarged top view of a portion of the vehicle cockpit further illustrating the charging region located on a center console of a vehicle with a portable chargeable device in proximity to the charger;

FIG. 3 is a block diagram of a wireless charging system, according to one embodiment;

FIG. 4 is a perspective view of the wireless charging system, according to one embodiment;

FIG. 5 is a schematic block diagram of a wireless charging system configured to provide charging status indication at locations inside the vehicle; and

FIG. 6 is a table illustrating indicators implemented by the wireless charging system based upon sensed charging status of the device, according to one embodiment.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

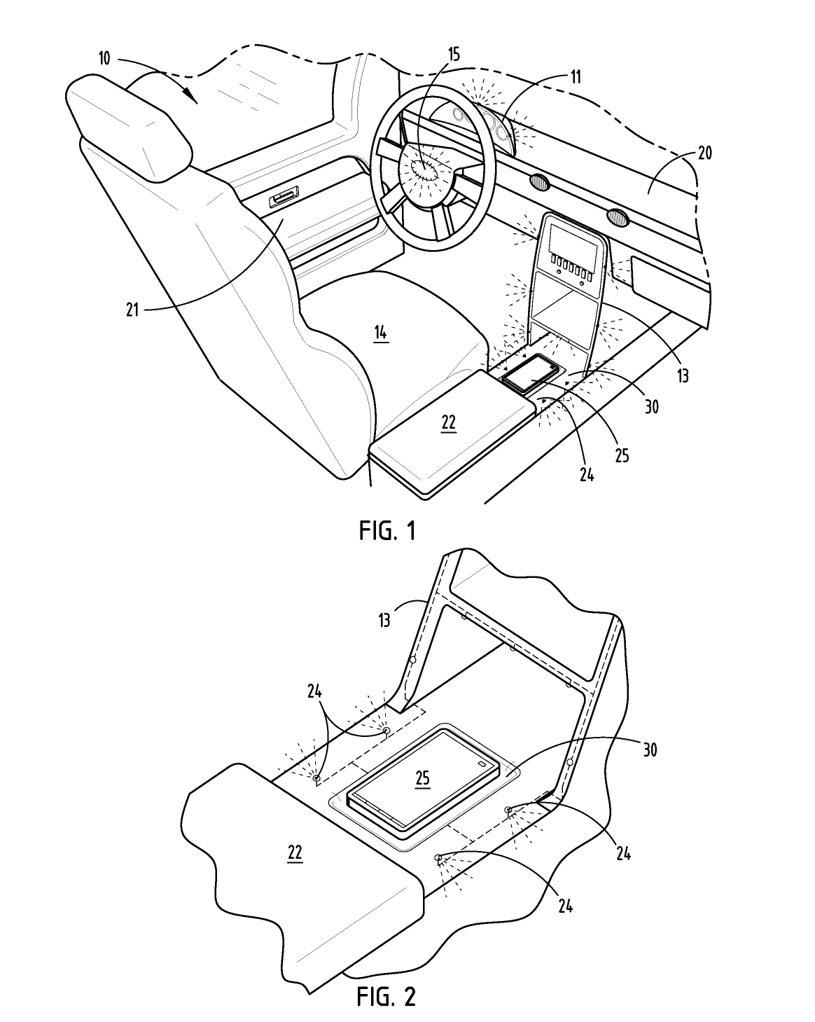

Referring to FIGS. 1 and 2, the interior of an automotive vehicle 10 is generally illustrated having a passenger compartment employing a wireless charging system 30, according to one embodiment. The vehicle 10 generally includes a seating arrangement including a front driver seat 14 adapted to seat a person as an occupant in the compartment of the vehicle 10. The vehicle 10 also includes a center console 18 with storage compartment 22 disposed between the driver front seat 14 and another passenger front seat (not shown), and side door armrests 21. The center console 18, center stack and dashboard 20, and armrests 21, as well as other vehicle assemblies, may be equipped with various device holders such as trays and storage compartments that may receive one or more devices for wireless charging. The vehicle 10 may further include rear seating and wireless charging trays and storage compartments configured for wireless charging located in the rear seating area. The vehicle 10 may also include components and areas that are capable of being illuminated by a vehicle illumination unit within the vehicle such as an instrument panel 11, a steering wheel 15, a portion 13 in proximity to a touch screen graphical user interface (GUI), and charging region 24. The instrumental panel 11 may include at least one portion disposed in front of the front driver seat 14 and the steering wheel 15 that can be illuminated. The steering wheel 15 may include a center hub mounted onto the center of the wheel that may be illuminated to show a particular emblem or design. The portion 13 may border the touch screen graphical (GUI)-providing illumination of objects surrounding the touch screen GUI. Charging region 24 may also be illuminated by lighting sources within and around the region 24.

FIG. 2 illustrates an enlarged view of a portion of the interior of the automotive vehicle 10 containing a wireless charging system 30. In the embodiment shown, a charging region 24 may be located on the center console 18 of the vehicle 10 and a portable chargeable device 25 may be placed on the surface of the charging system 30. The vehicle 10 may be equipped with one or more wireless charging systems 30 for wirelessly charging one or more devices, including one or more rechargeable batteries providing electrical power within an electronic device. In the embodiment shown and described herein, the wireless charging system is an inductive charging system. It should be appreciated that other forms of wireless transmission may be employed in the wireless charging system such as magnetic resonance, loose coupled resonance and electromagnetic radiation according to other embodiments. In one embodiment, one or more wireless charging systems 30 may be provided in one or more storage trays or dedicated trays provided in center console 18 or other areas in the vehicle cockpit. The wireless charging system 30 includes a wireless charger 26, such as inductive charger according to one embodiment. Inductive chargers typically include one or more inductive coils for generating electric signals in the form of an electromagnetic field (EMF) typically at low frequencies (sub 500 kHz) within a charging region 24. In the embodiment shown, the charging region 24 may be defined by a tray or a storage compartment having a bottom wall and side walls for receiving a device, such that the device when located within the charging region 24 may be charged via the electromagnetic field through inductive coupling.

According to another embodiment, the wireless charging system 30 may use a charging region 24 provided on one or more pads or trays provided in the vehicle dashboard 20. According to a further embodiment, the wireless charging system 30 may use a charging region 24 provided with a wireless charger 26 located in a tray within the armrest 21 extending from a vehicle door. In each of these embodiments, the wireless charging system 30 has a charging region 24 adapted to receive one or more devices, such as rechargeable batteries or electric-powered or electronic devices 25 employing rechargeable batteries that may be charged via an electric signal on the charging region 24 and may be accessible to the driver or other passengers within the cockpit 12 of vehicle 10. Examples of electronic devices 25 that may be charged by the charging system 30 include cell phones, tablets, cameras, Bluetooth ear pieces, portable radios, lighting devices, and music and video players.

FIG. 2 further illustrates that charging region 24 may provide a user with illumination within the vehicle. Charging region 24 may include various lighting sources that are mounted on region 24 and/or on areas in proximity to the charging region 24. It should be appreciated that any of a wide range of lighting sources can be used such as LEDs, incandescent light bulbs, discharge lamps, etc. Although the illumination shown in FIG. 2 is installed in and around charging region 24 which is shown in a central location between the front driver and passenger seats, it is appreciated that charging region 24 can be utilized in other areas within the passenger compartment, such as between or beside rear seating within the vehicle in a door tray, or elsewhere in the vehicle. In addition, vehicle 10 may include a vehicle interior lighting unit (explained in further detail below) that routes light to a plurality of different interior locations for illumination of lighting device(s) located within components and areas of the vehicle based upon communication between a vehicle function controller 52 and system 30. For example, the vehicle lighting unit may provide illumination of an instrument cluster, touch screen, instrument panel, storage receivers, gear levers, a hand brake and other vehicle components and areas that can be routed for illumination. The illumination from the lighting device(s) may come from existing ambient lighting devices in the vehicle, thereby allowing lighting devices to be utilized as a duplicative lighting assembly: as a wireless charging indicator and for providing illumination to a particular area of the vehicle.

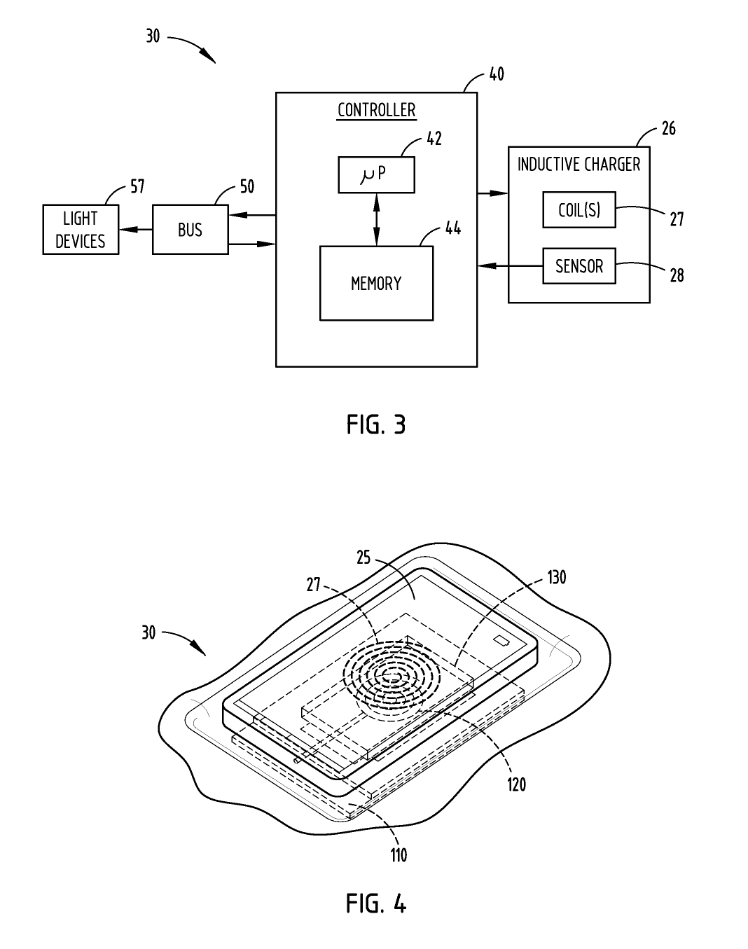

Referring to FIG. 3, the wireless charging system 30 is further illustrated having control circuitry shown in one embodiment as a controller 40 including a microprocessor 42 and memory 44. The controller 40 may include other or additional analog and/or digital circuitry. Controller 40 may process input information from memory and generate an output to the inductive charger 26 having inductive coil(s) 27 so as to wirelessly transfer electrical energy for the purposes of charging one or more rechargeable batteries provided in device 25. The controller 40 may receive as inputs 1) a signal indicative of the current charging status (e.g. fully charged, partially charged, or low charging state/fully discharged) and 2) information from a vehicle connectivity system via a network bus 50 related to at least one determination of a current charging status of device 25 detected via wireless technology or a Universal Serial Bus (USB) port of the vehicle connectivity system. The information sent from the vehicle connectivity system may also include a request to controller 40 to determine if device 25 on wireless charging system 30 is charging and a request for the charging status of the device being charged. Alternatively, controller 40 may periodically broadcast a message indicating the charging status of device 25 to the vehicle connectivity system without first needing to receive a request for the charging status from the connectivity system, thereby illuminating various components and areas of the vehicle.

In the embodiment shown, inductive charger 26 may also include a sensor 28 to sense the presence or absence of receivers of device 25 to be charged when the device 25 is placed into the transmitter area of wireless charging system 30. The sensor 28 may also measure the stored charging status of the battery within device 25. Chargeable device 25 may be configured to transmit information indicating stored charging status and system 30 may be configured to receive a signal from device 25 indicative of a charging status of device 25. The transmitted information may indicate that the device is fully charged, partially charged or low charging state/fully discharged. In another embodiment, an in-vehicle connectivity system enabled with a particular wireless communication protocol may synchronize with the device 25 that is also enabled with the same protocol. Examples of wireless communication protocols that may be used by a chargeable device and compatible with vehicle connectivity system 54 include Bluetooth, infrared, 2-way UHF key fobs, and IEEE 802.11 technologies. In such cases, the charging status information may be communicated directly to and from device 25 to a vehicle connectivity system without requiring sensing of the charging status of device 25 by system 30.

In addition, sensor 28 may measure if device 25 on system 30 is not capable of charging due to misalignment or charging at less than optimal charging due to poor alignment. Detection of such states of misalignment of device 25 by system 30 may be achieved by configuring sensor 28 to measure the amount of power that is being transferred to device 25 by system 30. Such measured power information may then be sent to controller 40 which processes the information and determines how much of a deviation the measured power is from a predetermined value or range of values stored in memory 44 which signify optimal alignment and charging. If the calculated deviation is beyond one or more predetermined threshold values or range of values, device 25 may be considered significantly misaligned to the extent of incapable of adequate charging for system 30 to charge device 25 or unable to charge optimally because of less than optimal alignment. It should be appreciated that other methods of sensing misalignment of device 25 may also be used. In addition to information pertaining to the charging statuses of the device battery detected by controller 40 and detected misalignment of device 25, other information pertaining to the charging of device 25, such as a malfunction of system 30 may be detected by controller 40 and communicated via vehicle bus 50 to the vehicle connectivity system. Such communication may be between the controller 40 and the vehicle function controller 52 such that the vehicle function controller 52 adjusts (via a vehicle lighting unit) at least one illumination of a plurality of a components and/or areas inside the vehicle based on the message received from system 30. The illumination provides an indication of the sensed status of device 25 to the user within the vehicle allowing the user to easily determine the charging status of the device being charged without impairing the occupant's ability to perform important functions in the vehicle such as driving or paying attention to the road.

FIG. 4 illustrates one implementation of the charging components of the receiver device on a wireless charging system 30 in relation to the device receiver coil according to one embodiment. In FIG. 4, a transmitter section 110 may be housed in charging system 30. The transmitter section 110 may contain one or more transmitter coils (not shown) which may be coupled to a connector that is plugged into a standard external power source. A receiver 130 may be housed in chargeable electronic device 25. The transmitter section 110 may provide power to the receiver 130 such that the receiver 130 with receiver coils 120 provides power to a rechargeable battery and the transmitter section 110 may receive additional control information from receiver 130 to adapt to a particular power transfer based on the control information.

The vehicle charging system 30 may include one or more wireless chargers for generating electric charging signals in a charger region 24 to charge electronic device 25 containing a rechargeable battery. The wireless charger may include a charger 26 generating an electromagnetic field. The charger may include one or more inductive coils 27 located below or on the bottom surface of the charger region 24 such as a pad for generating an electromagnetic field in the charger region 24. The electromagnetic field passes from inductive coils 27 into the charger region 24 and is intended to wirelessly couple to one or more inductive receiver coils 120 provided in the portable electronic device 25 so as to transfer electrical energy thereto for purposes of charging one or more rechargeable batteries. As a result, an electromagnetic field is present within the charger region 24.

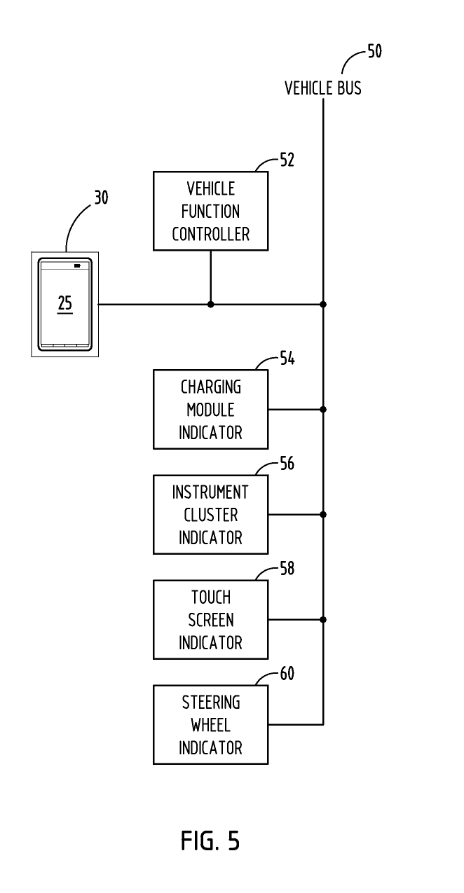

FIG. 5 shows a schematic illustration depicting one embodiment of an adaptable wireless communication system including a network connection between wireless charging system 30 and an integrated vehicle system that includes a lighting system that directs light to a plurality of interior locations for illumination of the locations inside the vehicle. Such interior locations may include a charging module indicator 54, instrument cluster indicator 56, touch screen indicator 58 and steering wheel indicator 60. Charging system 30 may interface with a plurality of networks via a vehicle bus 50 such as a privately accessible network such as WAN/LAN, publicly accessible networks such as the Internet, in-vehicle networks such as Controller Area Networks (CAN), Assembly Line Data Link (ALDL) and Local Interconnect Network (LIN). When the charging system 30 is connected to an in-vehicle data bus 50, the controller 40 in wireless charging system 30 may provide charging status information and/or issue commands based upon detected charging status of chargeable device 25 to a vehicle function controller 52 connected to the vehicle integrated system. The vehicle function controller 52 may then, based upon the status message from system 30, broadcast a message to an in-vehicle lighting system which would process the message and control the amount and type of lighting within and/or surrounding illumination regions of the vehicle. Alternatively, the charging status of device 25 may be measured directly by the vehicle function controller 52 connected to the in-vehicle connectivity system if the in-vehicle connectivity system is enabled with a wireless communication protocol that device 25 is compatible with. In such cases, the charging status information may be communicated directly from device 25 to the in-vehicle connectivity system for adjusting illumination of components and areas inside the vehicle without requiring first sensing of the charging status of device 25 by controller 40 of system 30.

A charging module indicator unit 54 may be contained and equipped inside vehicle 10. The charging module indicator unit 54 may include illumination sources within and surrounding charging region 24. It should be appreciated that any of a wide range of illumination sources can be used such as LEDs, incandescent light bulbs, discharge lamps, etc. In addition, the illumination sources may be mounted in concealed locations within charging region 24 thereby providing for aesthetically-pleasing lighting of bins, trays, cup holders, and other receptacles that may also be contained within charging region 24. Openings within the charging region may also be used to allow light from the illumination sources to escape and better illuminate surrounding areas of the charging region 24. An in-vehicle lighting system may control the amount of lighting, a lighting pattern such as flashing on and off and/or type of lighting such as color or hue that is delivered to the illumination sources of the charging module indicator unit 54 based upon the detected charging status of device 25.

Other areas inside the vehicle where illumination may be adjusted via communication between an in-vehicle connectivity system and charger 30/device 25 to indicate a particular charging status to a user may be the instrument cluster indicator unit 56, an indicator unit in proximity to a touch screen GUI 58 and a steering wheel indicator 60. Additional interior locations within the vehicle where lighting could be adjusted such that the occupant of the vehicle could easily determine the charging status of the device being charged without focusing their eyes off the road include the door handle, belt buckle, door lock, sunroof, hand brake, level regulator, and a foot space. The illumination may come from existing ambient lighting devices in the vehicle, thereby allowing lighting devices to be utilized as a duplicative lighting assembly: as a wireless charging indicator and for providing illumination to a particular area of the vehicle.

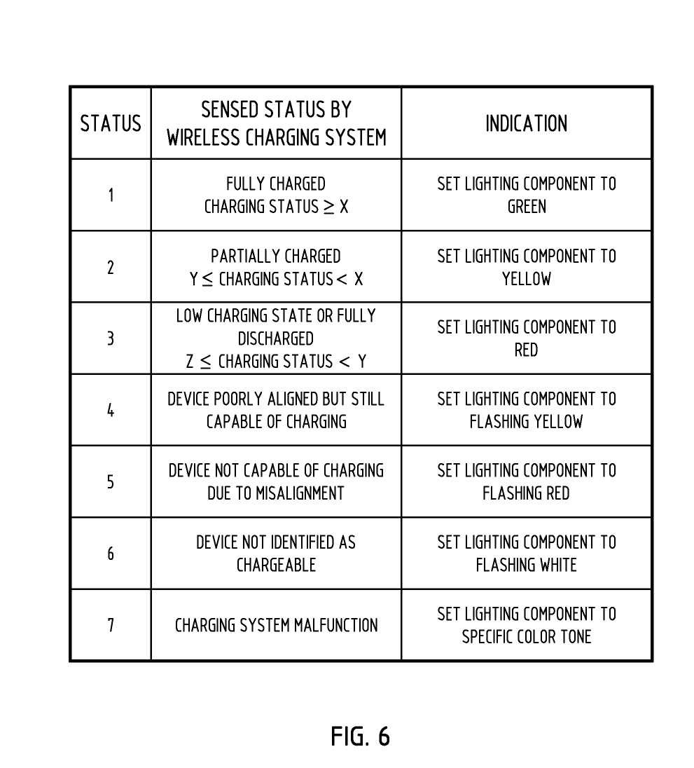

The table shown in FIG. 6 illustrates one exemplary embodiment of illumination indications that may be provided in different interior locations of the vehicle depending on at least one sensed charging status of chargeable device 25. As shown in rows 1-3 of FIG. 6, a chargeable device 25 may be detected by system 30 as fully charged, partially charged or low charging state/fully discharged. Chargeable device 25 may be configured to transmit information indicating stored charging status to charging system 30. System 30 may then configure the transmitted information from device 25 to classify the information within a particular charging range. For example, if the charging status information packet from device 25 contains a charging status value that is between a predetermined charging status range of greater than or equal to Y value but less than or equal to X value, the device will be classified as “partially charged.” In such a case, wireless charging system 30 may broadcast a message to the vehicle function controller 52 of the in-vehicle connectivity system indicating for the vehicle illumination unit to deliver substantially green lighting to the charging module indicator unit 54, thereby lighting the illumination sources green within and surrounding charging region 24. This illumination of the charging region 24 and/or other conveniently noticeable illumination locations of the vehicle allow the occupant of the vehicle to easily determine the charging status of the device being charged without affecting the occupant's ability to perform important functions within the vehicle such as driving or paying attention to the road.

As shown in rows 4-5 of FIG. 6, the chargeable device 25 may be detected by system 30 as poorly aligned for charging on charging system 30 but still capable of being charged or completely incapable of charging because of misalignment. In some embodiments, degree of misalignment may be detected by an alignment measuring circuit within system 30 that determines the proximity of certain communication chips that are within the receiver of device 25 and the transmitter of system 30. Higher levels of misalignment (i.e., wherein the device is incapable of charging due to the degree of misalignment) may be detected by the amount of distance between certain chips located in the receiver of device 25 and other ones located in the transmitter of system 30. Alternatively, detection of the amount of misalignment of device 25 by system 30 may also be achieved by configuring system 30 to measure the amount of power that is being transferred to device 25 by system 30. Wireless charging system 30 may subsequently broadcast a message regarding the detected level of misalignment to the vehicle function controller 52 of the in-vehicle connectivity system indicating for the vehicle illumination unit to deliver a visual indication to the user depending on what level of misalignment was found. As an example, in the embodiment shown in FIG. 5, if system 30 determines that the device is poorly aligned but capable of being charged, the vehicle illumination unit would flash yellow illumination within and surrounding charging region 24 and/or other optional locations of vehicle 10 such as the instrument cluster indicator 56 or touch screen indicator portion 58.

As shown in row 6, system 30 may also determine whether the device 25 detected is capable of being charged inductively by system 30. This may be achieved by determining if the size and/or mass of the device meet certain predetermined thresholds for size and/or mass. If system 30 determines the device is within the threshold criteria, then it is expected that the device is capable of being charged by the charging system 30. As shown in row 7, system 30 may also send out a message to the vehicle function control if the charging system has been detected as malfunctioning. For example, sensor 28 detecting that that transmitter section 110 of system 30 is not providing sufficient power despite the receiver of device 25 being detected as sufficiently aligned on system 30 may indicate that system 30 is malfunctioning. If device 25 is identified as not capable of charging or system 30 is detected as malfunctioning, system 30 may broadcast at least one status message pertaining to device incapacity for charging or wireless system malfunction to the vehicle function controller 52 via vehicle bus 50. The vehicle function controller 52 will then communicate with a vehicle illumination unit to deliver a visual indication to the user reflective of the particular status identified. In the embodiment shown in FIG. 6, if system 30 determines that device 25 is not chargeable, the vehicle illumination unit would flash white illumination within and surrounding charging region 24 or within and/or surrounding other optional locations of vehicle 10 such as the instrument cluster or touch screen icon indicator. If it is determined that system 30 is malfunctioning, the vehicle illumination unit would set the illumination within and surrounding charging region 24 or within and/or surrounding other optional locations of vehicle 10 such as the instrument cluster or touch screen icon indicator to a specific non-red or green or yellow color and tone.

As will be appreciated, center charging region 24 can be implemented as a drop-in center console module that includes an integrated illumination unit which provides area illumination of a region external to the console. Of course, the actual size, shape and other design features of charging region 24 as well as other indicator locations within the vehicle will normally depend on the aesthetic and functional design of the particular vehicle application and will not be limited to the specific embodiments shown in the foregoing description. Various changes and modifications will become apparent to those skilled in the art. For example, although setting green lighting surrounding and within charging region 24 or other possible areas of the vehicle capable of illumination may indicate a fully charged status, it will be appreciated that other forms of indication may also be utilized to indicate a fully charged status such as a specific audio indication or a greater intensity of illumination relative to a partially charged or discharged status.

Accordingly, it is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A wireless charging system comprising:
a wireless charger for charging a chargeable device in a charging region in a vehicle;
a controller that detects a charging status of the chargeable device in the charging region; and
a light indicator in proximity to or on the charging region for indicating the charging status by illuminating one or more light sources.

2. The system of claim 1, wherein the indicator of the charging status includes illuminating a particular color of at least one or more of the light sources.

3. The system of claim 1, wherein the charging region is provided in a console or tray within the vehicle.

4. The system of claim 1, wherein the charging region is one of an instrument cluster indicator, a touch screen indicator, or an instrumental panel indicator.

5. The system of claim 1, wherein the controller detects misalignment of a chargeable device in proximity to the charger and providing an indication of misalignment of the device.

6. The system of claim 5, wherein the indication of misalignment is a flashing of at least one light source in proximity to or on the charging region.

7. The system of claim 5, wherein detecting misalignment comprises determining whether the device is incapable of charging due to misalignment.

8. The system of claim 1, wherein the controller determines the charging status as fully charged, partially charged or discharged based upon detected charging status.

9. The system of claim 1 further comprising detecting malfunction of the charger and setting at least one light source to a predetermined color based on detected malfunction.

10. The system of claim 1, wherein the indication of the charging status is a flashing of a particular color of at least one light source in proximity to or on the charging region.

11. A method for indicating charging status in a wireless charging system, the method comprising:
inductively charging a chargeable device with a wireless charger in a charging region in a vehicle;
detecting a charging status of the chargeable device; and
providing an indication of the charging status to a user, wherein the indication is an illumination of one or more light sources provided in proximity to or on the charging region.

12. The method of claim 11, wherein the indication of the charging status includes illuminating a particular color of at least one or more of the light sources.

13. The method of claim 11, wherein the charging region is provided in a console or tray within the vehicle.

14. The method of claim 11, wherein the charging region is one of an instrument cluster indicator, a touch screen indicator, or an instrumental panel indicator.

15. The method of claim 11 further comprising detecting misalignment of a chargeable device in proximity to the charger and providing an indication of misalignment of the device.

16. The method of claim 15, wherein the indication of misalignment is a flashing of at least one light source in proximity to or on the charging region.

17. The method of claim 15, wherein detecting misalignment comprises determining whether the device is incapable of charging due to misalignment.

18. The method of claim 11 further comprising determining the charging status as fully charged, partially charged or discharged based upon detected charging status.

19. The method of claim 11 further comprising detecting malfunction of the charger and setting at least one light source to a predetermined color based on detected malfunction.

20. The method of claim 11, wherein the indication of the charging status is a flashing of a particular color of at least one light source in proximity to or on the charging region.
